(19) United States
(12) Patent Application Publication
(10) Pub. No.: US 2023/0275822 A1
(43) Pub. Date: Aug. 31, 2023

(54) GEOLOCATION OF CABLE MODEMS

(71) Applicant: ARRIS Enterprises LLC, Suwanee, GA (US)

(72) Inventors: Chris R. ZETTINGER, Wheaton, IL (US); Yair NEUGEBOREN, Netanya (IL)

(73) Assignee: ARRIS Enterprises LLC, Suwanee, GA (US)

(21) Appl. No.: 18/105,655

(22) Filed: Feb. 3, 2023

Related U.S. Application Data
(60) Provisional application No. 63/314,829, filed on Feb. 28, 2022.
(60) Provisional application No. 63/394,246, filed on Aug. 1, 2022.

(51) Int. Cl. H04L 43/0864; H04L 12/28; H04L 69/28

(52) U.S. Cl. CPC H04L 43/0864; H04L 12/2801; H04L 69/28

(57) ABSTRACT

Using timing delays and values associated with plant information between a CMTS, R-PHY device or a remote MACPHY device and user devices on a network to determine the distance between a head end device, for example a CMTS, R-PHY device or a remote MACPHY device and an end-user device such as cable modem in order to alert to a stolen, outdated, misplaced or otherwise at-risk end-user device.

This application claims the benefit of U.S. Provisional Patent Application Ser. No. 63/394,246 filed Aug. 1, 2022; and claims the benefit of U.S. Provisional Patent Application Ser. No. 63/314,829 filed Feb. 28, 2022.

### TECHNICAL FIELD

This disclosure relates to determining distance between a CMTS and a modem device.

### BACKGROUND

The Data-Over-Cable Service Interface Specification (DOCSIS) was established by cable television network operators (also referred to as multiple service operators or MSOs) to facilitate transporting data traffic, primarily Internet traffic, over existing community antenna television (CATV) networks. In addition to transporting data traffic, as well as television content signals over a CATV network, MSOs can also use their CATV network infrastructure for carrying voice, video on demand (VoD) and video conferencing traffic signals, among other types.

Subscribers can access these services through user devices, which can include, for example, cable modems, embedded multimedia terminal adapters (EMTAs) (also known as cable telephony modems), set-top boxes, or gateway devices. A subscriber can have one or more user devices capable of receiving data services registered with a service provider, such as an MSO. Once a device is registered to a subscriber, its identifier, for example its media access control (MAC) address, can be used to authorize it to receive signals, including those for data service. If a subscriber were to provide one of his or her devices to a non-subscriber such as, for example a neighbor, the device might still be authorized by the network to receive signals, resulting in the provision of services to both the subscriber and the non-subscriber user. The subscriber might for example, decide to split the bill for services with the non-subscriber. As another example, the movement can be of a DOCSIS compliant set-top box. Typically, discounts are provided for the second (or more) set-top boxes that a subscriber has in his or her home. Whatever type of arrangement exists between the subscriber and the unauthorized user, there is the potential that a service provider such as an MSO can lose a substantial amount of revenue due to such fraudulent sharing of devices. Further, determining whether a device is no longer where it was originally installed can be used in the emergency 911 context as well wherein operators would like to determine the origin of a call. Additionally, certain characteristics of a device, for example, the make, model, installation date, and capabilities of the device can alert a provider of outdated or non-working equipment.

Efficient problem diagnosis for network infrastructure has grown in importance as network services have become more ubiquitous. Such network services can include cable service. Currently, one example cable architecture is a hybrid fiber coax (HFC) architecture. An HFC architecture can employ fiber optic cable for the long distance from a hub (or headend) site to a node. A hub site (or headend) is a source point for downstream signals and a destination point for upstream signals. A fiber node can include a grouping of approximately five-hundred homes passed. Inside a node the signals are distributed via coaxial cable to customer premise equipment (CPE) devices, which are typically located inside a home, apartment, or office. A CPE device can be a cable modem (CM), multimedia terminal adapter (MTA), set-top box (STB), or gateway device. A coaxial cable plant divides two-way signals by frequency between upstream and downstream components. The sub-split return is used by many current HFC networks, which means that signals for the return path are separated from the forward path at the sub-very-high frequency band. A coaxial portion of the cable plant is built with a tree-and-branch architecture, so an outage on a fiber node branch can potentially affect multiple subscribers in different geographic locations.

Another example architecture is Remote PHY (Physical), or R-PHY, which is an extension of DOCSIS. Remote PHY addresses the limitations of analog fiber and the Hybrid Fiber-Coaxial (HFC) bottleneck, breaking through by unlocking major bandwidth increases in existing access networks by splitting Cable Modem Termination System (CMTS) functions so that the Converged Cable Access Platform (CCAP) core and physical-layer functions run separately in different locations.

Yet another architecture is Remote MAC/PHY, or RMD, which can enable remote MAC/PHY products from multiple vendors to interoperate.

Diagnosis of a network problem can be performed using software that communicates with the CPE devices. Cable service assurance involves the identification and subsequent troubleshooting of problems in a-network such as an HFC network or other network architectures, for example as described herein. A problem can originate from a CPE device, a fiber node, a cable modem termination system (CMTS), an R-PHY device or a remote MACPHY (RMD) device. A fiber node can connect the CMTS, R-PHY device or a remote MACPHY device to a CPE device or devices. An important diagnosis is identifying the particular fiber node that is associated with a CPE device experiencing an outage. Several inputs to and outputs from multiple fiber nodes can be summed together to provide connectivity to a single CMTS at a hub site. As a consequence, there is no obvious and reliable method to identify the connectivity information relating to a fiber node with a CPE device. Typically, the billing data of a CPE device can be used to identify the fiber node information. However, the billing data can often become out-of-date and costly to update regularly. Therefore, there remains a need for a more accurate and reliable way to determine the distance between a CMTS and a modem, between a Remote PHY device (RPD) and a cable modem or between a Remote MACPHY device (RMD) and a cable modem. Accomplishing such determinations thereby broadens the scope of the current technology from central access architectures (with CMTS) to include distributed access architectures (with RPD and RMD).

Hybrid Fiber Coaxial (HFC) networks provide a wide bandwidth and represent the solution of choice for many residential networks. The Data Over Cable Service Interface Specification (DOC SIS) protocol is an important standard for HFC networks and is supported by the majority of current vendors. This protocol uses various algorithms to resolve collisions within the network by means of determining distance to a cable modem using either the ranging information that was obtained as part of the cable modem initialization process or the RF power levels at the CMTS or cable modem. However, the performance of these methods tends to deteriorate when the network load is high or there is a lot of noise on the network. Ranging provides a total round trip delay from the cable modem to the CMTS and back but does not account for the delay asymmetry inherent in the upstream and downstream paths. RF power levels can be affected by amplifiers in the coaxial cable plant. DTP as a protocol to accurately determine the distance from a CMTS to the cable modem is unique. DTP accounts for delay asymmetry to allow the overall delay and as a result, distance to a particular modem to be accurately determined. This can be used an aid to troubleshooting network issues and provide additional information in cases where records are missing or outdated.

### BRIEF DESCRIPTION OF THE DRAWINGS

FIG. 1 is a block diagram illustrating an example network environment showing an HFC network coupled to a headend and multiple user devices.

FIG. 2 is a diagram illustrating an example transmission map scheduling the transmission of data by user devices.

FIG. 3 is a diagram illustrating an example of a movement of an authorized device to another location on the network.

FIG. 4 is a simplified linear representation of an example network.

FIG. 5 is a diagram illustrating an example of a distance determination being made in the network.

Like reference numbers and designations in the various drawings indicate like elements.

### DETAILED DESCRIPTION

In some implementations of this disclosure, systems and methods can operate to alert of possible fraud resulting in the movement of an authorized device from one physical location to another, and in particular from a location owned or rented by a subscriber to another location owned or rented by a non-subscriber.

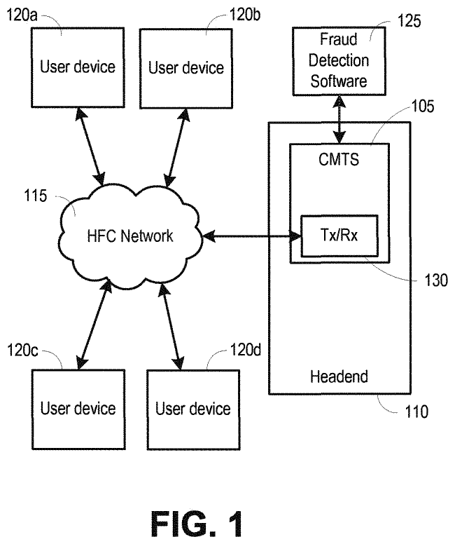

FIG. 1 is a block diagram illustrating an example network environment 100 that can include a modulation/demodulation device, such as a cable modem termination system (CMTS) 105 located at a network provider's edge serving office. By way of example, the office can be, for example, a headend 110 of a multiple service operator (MSO), such as a cable company. FIG. 1 can also include one or more transport networks connecting the headend to user devices, such as a Hybrid Fiber-Coaxial (“HFC”) network 115, through which one or more user devices 120a-d can communicate with the CMTS 105. It should be understood that only four user devices 120a-d are shown (for illustrative purposes), but more are typically deployed. FIG. 1 can also include a software program or module 125 operable to obtain and process information to alert of possible fraud. In addition to a network that uses cable infrastructure, it should also be understood that any network in which an authorized user device can be moved from one physical location to another and still be recognized as authorized to receive signals is contemplated to be within the scope of this disclosure.

In some implementations, a headend 110 can provide video, data, and voice service to a subscriber. The CMTS 105 can include a processor, a memory, and a storage device. The CMTS 105 can also have one or more transmitters/receivers 130 for transmitting signals through one or more transport networks, including the HFC network 115, to one or more user devices 120a-d. The transmitters/receivers 130 can be one or more separate transmitter and receiver components residing on the same board, or separate boards; further, the transmitter and receiver can also include various sub-components, such as modulators and demodulators. The CMTS 105 can also receive data signals from user devices through one or more transport networks, including the HFC network 115.

The example HFC network 115 can use a combination of optical fibers and coaxial cable to send data to and receive data from the headend 110. The HFC network 115 can be bi-directional wherein signals are carried in both directions on the same network from the headend 110 to the user devices 120a-d, and from the user devices 120a-d to the headend 110. The downstream signals, which can also be referred to as forward-path signals, carry information from the headend 110 to the home such as video content voice, and internet data. The upstream signals, which may also be referred to as return-path signals, carry information from user devices to the headend 110, such as control signals to order a movie, or internet data such as email.

The optical fiber portion of an HFC network 115 can extend from the headend 110 (e.g., including centralized, local, or regional headend) to a hub site for one or more neighborhoods, and then to a fiber optic node. The co-axial portion of an HFC network 115 uses co-axial cable connecting the fiber optic node to a plurality of homes having end user devices 120a-d. In example implementations, the HFC transmitter/receiver 130 can transmit communications directly to an HFC network (e.g., HFC network 115 of FIG. 1). In other implementations, the HFC/modulation interface 340 can transmit communications to a modulator (e.g., an EQAM, combiner, mixer, etc.) for generation of an RF signal for transmission on an HFC network. The various signals from the headend 110 may be encoded, modulated, and/or upconverted onto RF carriers, combined onto an electrical signal and inserted into a broadband optical transmitter. The broadband optical transmitter can be operable to convert the electrical signal to a downstream optically modulated signal that is sent to one or more fiber optic nodes. An example fiber optic node has a broadband optical receiver which converts the downstream optically modulated signal into an electrical signal operable to propagate through co-axial cables to end user devices 120a-d. The downstream electrical signal can be a radio frequency (RF) modulated signal. The forward-path and the return-path may be carried over the same coaxial cable in both directions between the optical node and the end user devices. To prevent interference of signals, the frequency band may be divided into two or more sections in which at least one frequency band carries forward-path signals, and at least another that carries return-path signals. For the at least one return path, one of the user devices 120a-d transmits on a given frequency at any given time. However, it should be noted that multiple user devices 120a-d can transmit at different frequencies simultaneously. Typically, requests for upstream bandwidth are made by the user devices 120a-d. The CMTS 105 might grant or deny such requests based upon various characteristics such as, for example, network usage, previous requests for grants, etc. In some implementations, the CMTS 105 can generate one or more transmission maps that allocate user devices 120a-d a specific time slot and frequency at which the user devices 120a-d may transmit. The transmission maps can be generated using, for example, an enhanced concatenation and fragmentation algorithm such as specified in DOCSIS 3.0, or any other suitable algorithm.

The transport network connecting the headend to user devices can also include one or more radio frequency over glass (RFoG) networks, which can be deployed with an existing HFC network 115. An RFoG topology includes an all-fiber service from the headend 110 to a field node, or optical network unit (ONU), which is typically located at or near the user's premises. Coaxial cable can be used to connect the ONUs of an RFoG network to one or more user devices 120a-d. In the headend, a downstream laser sends a broadcast signal that is optically split a multitude of times. The optical network unit or ONU recovers the RF broadcast signal and passes it into the subscriber's coax network.

Upstream transmissions from the user devices 120a-d can pass through an RFoG network and be received by an RFoG transmitter/receiver at the headend. The user devices 120a-d can transmit RF signals to their respective ONUs. The ONUs can modulate the upstream RF traffic onto optical channels and sends those signals to an optical splitter, which then passes on the signals on the optical channels to the RFoG transmitter/receiver. In various implementations, the RFoG transmitter/receiver can be one or more separate transmitter and receiver components residing on the same board, or alternatively separate boards; further, the transmitter and receiver can also include various sub-components, such as modulators and demodulators. The RFoG transmitter/receiver receives the optically modulated signals on optical channels and demodulates the signals into the electrical signals, which can be RF signals. Signals from the RFoG network can then be combined with one or more RF signals coming from other HFC networks such as HFC network 115, or from other RFoG networks using an RF combiner, before being received by the CMTS transmitter/receiver 130.

FIG. 1 also shows one or more software programs or modules, fraud detection software 125, operable to use information regarding the physical location of a user device and timing delays associated with the device at different times to alert of possible fraud. The software can reside, for example, in the CMTS 105, or on a blade of the CMTS 105, or on a separate computer. The fraud detection software 125 can also be operable to request and obtain subscriber information, and also information on timing delays associated with the device at different times. Such information can reside in one or more databases, which can be associated with a subscriber billing system, the CMTS 105, a provisioning system, or any other databases.

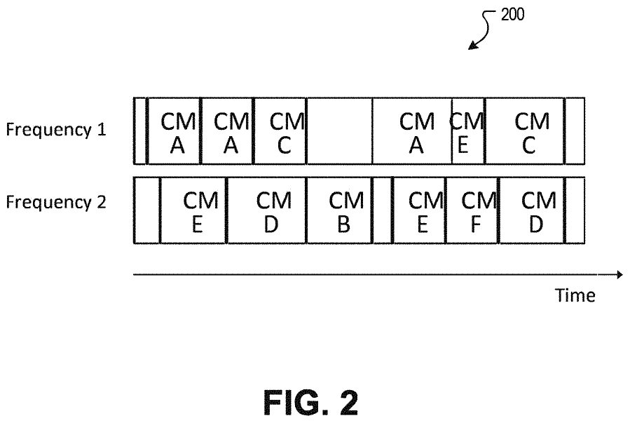

FIG. 2 illustrates an example transmission map 200 having one or more frequencies, and one or more time slots (also referred to as burst frames) for each frequency, wherein the user devices (e.g., user devices 120 of FIG. 1) can be, for example, cable modems A, B, C D, E, and F coupled to an HFC network (e.g., HFC network 115 of FIG. 1). While six devices and two frequencies are shown for illustrative purposes, more frequencies, more user devices can be employed. The transmission map 200 can be allocated such that the user devices on the HFC network can transmit over different frequencies at the same time, consistent with DOCSIS 3.0 upstream channel bonding.

A transmission map 200 allows for a user device to determine when and at what frequency to transmit information so as to avoid conflicts that can result in the loss of data. User devices can connect to the transport network at various physical locations. Based on a number of factors, including, for example, the varying distance of each user device from the headend, it can take a signal longer to reach the headend if it is transmitted from one device versus another, even if both transmissions occur at the same time. Because of such a timing delay, timing offsets are associated with each user device so that the timing delay is accounted for by user devices that transmit according to a transmission map 200. Without timing offsets, the potential exists that one user device transmission can overlap with that of another user device, resulting in collisions and possible loss of data that might require a re-transmission.

Returning to FIG. 1, when a user device 120 is initially connected to the network, for example when a cable modem is connected to a coaxial outlet in a residence, several processes can be performed. For example, the CMTS 105 might obtain the Media Access Control address of the device (the “MAC” address) and associate it with the user's subscriber account which can contain billing information, such as, for example, the subscriber's address.

Although various implementations can be used to determine the timing delay of a device's transmission to a receiving device, a synchronization process can be performed whereby transmissions are sent between the headend 110 and the user device 120 to determine the timing delay of the user device 120 and the appropriate timing offset needed to account for the timing delay. As mentioned above, such a timing delay might also exist for other devices and other architectures, such as the timing delay of a DSL modem transmitting to a DSLAM at a central office of a telephone company.

In an implementation employing DOCSIS, the CMTS 105 sends a “SYNC message” to a user device 120. Upon receiving the SYNC message, the user device 120 sets its system clock to time unit 0. It for example, a time unit of 3 has passed, then the CMTS 105 clock time will read 3 when the user device clock time has been set to 0.

The CMTS 105 will then send a MAP message (transmission map message) instructing the user device 120 to send a “Ranging Request” to the CMTS 105. For example, the CMTS 105 might send the MAP message at CMTS 105 clock time 5, asking the user device 120 to transmit the ranging request at the user device 120 clock time 12. By the time the user device 120 receives the message, the user device 120 time will be 8. The user device 120 will send out the ranging request according to its own clock at time 12. With a one-trip delay of 3-time units, by the time the ranging request is received by the CMTS 105, the user device 120 time clock will read 15 and the CMTS 105 time clock will read 18. In this example, the CMTS 105 asked for the user device 120 to transmit at CMTS 105 time clock 12. If there were no timing delays at alt it would have received a ranging request at 12. Because of the round-trip delay of 6-time units, the CMTS 105 received the ranging request from the user device 120 at CMTS 105 time clock 18. The CMTS 105 then sends a “Ranging Response” message to the user device 120 letting it know that its timing offset is 6 time units.

When the CMTS 105 sends a transmission map, for example the transmission map like the one shown in FIG. 2, to the user device 120 letting it know during which time slots it should transmit the user device 120 will use the timing offset to make sure that the CMTS 105 begins to receive data at the requested allocated start time. Thus, a CMTS 105 might send a transmission map indicating that user device 120a is allotted a time slot starting at T=30, meaning that the CMTS 105 expects to begin receiving transmissions from user device 120a starting at CMTS time clock 30. Using the offset of six derived from the example above, because the user device 120a clock is already 3 units ahead, and it will take 3 time units for a transmission to get to the CMTS 105, the user device 120a will send out its transmission at user device 120 clock time T−6, which is user device 120a time 30 −6=24. The transmission would arrive at CMTS 105 time 30. Units of time can be expressed in DOCSIS “ticks” wherein each tick=6.25 μsec. The timing offset can be quoted in units of 1/64th of a DOCSIS tick, which makes one Time Offset unit equal to 97.65625 nanoseconds.

It should be noted again that various implementations using offsets and ranging can be used to determine the timing delay of a device's transmission to a receiving device, including a high-resolution timing offset available in some versions of DOCSIS, and methods used in non-DOCSIS networks.

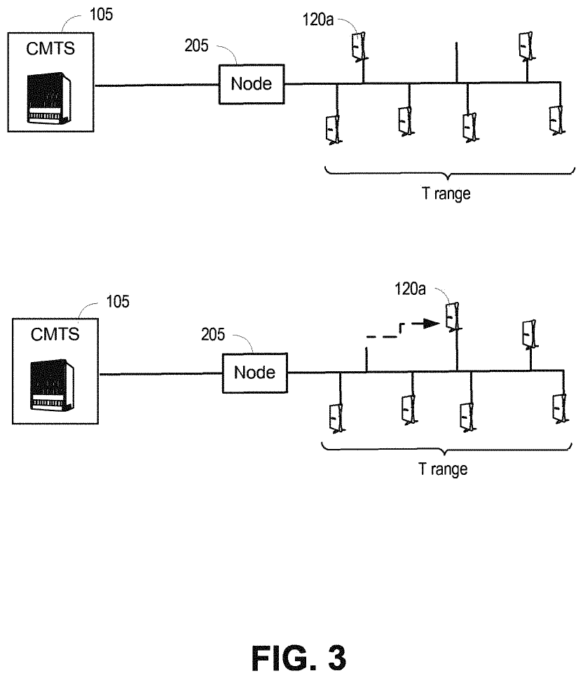

FIG. 3 is an illustration of an example implementation in which user devices 120 connect to a modulation/demodulation device, such as CMTS 105, located at a headend 110. Multiple user devices 120 can be connected to the headend via one or more nodes 205. The node 205 might be, for example, a fiber optic node of an HFC transport network. The node 205 might also be, for example, an RFoG transmitter/receiver at the headend.

FIG. 3 illustrates a situation in which a user device 120a has been moved from one part of the network to another. For example, a cable modem connected to a coaxial cable outlet in one room of a residence might be moved to another room and connected to the coaxial cable outlet of that room. As another example, the movement can be of a DOCSIS compliant set-top box. When a user device 120a is authorized to receive a service, such as when a DOCSIS compliant cable modem is authorized to receive data service, a subscriber can provide one of his or her user devices 120 to a non-subscriber such as, for example a neighbor. The device might still be authorized by the network to receive signals, resulting in the provision of services to both the subscriber and the non-subscriber user. The subscriber might for example, decide to split the bill for services with the non-subscriber. Whatever type of arrangement exists between the subscriber and the unauthorized user, there is the potential that a service provider such as an MSO can lose a substantial amount of revenue due to such fraudulent sharing of devices.

When a user device 120 is physically moved, even if it is from one room to another, the result will be a change in the timing delay and timing offset of the user device 120. There can be many factors that influence the timing delay. Significant amongst these factors are the length of the cables (i.e., physical distance of the path between the user device 120 and the receiving device CMTS 105, for example). Other factors that can influence the timing delay can include the downstream model of the user device 120 and the firmware running on the user device, and even the temperature surrounding cabling.

A difference between the initial or previous timing delay and a subsequent timing delay can be used as a “red flag” to alert of potential fraud. In example implementations, fraud detection might be enhanced if the demographics of the neighborhood(s) in which the user devices 120 reside (or that a node 205 serves) are considered in conjunction with changes in the timing delay of the user device 120. In particular, a movement resulting in a delay of a certain number of ticks might for example, correspond to a conservative estimate that a user device 120 was moved 160 feet. If a subscriber resided on a large lot or estate and had multiple user devices 120, such as a cable modem and a gateway device or set-top box, for example, then a movement of a user device 120a a distance of 160 feet might constitute a move from one part of the residence to another, considering the size of the estate. To consider as a factor data regarding whether a subscriber lives in an estate, suburb, or rural area can eliminate a “false positive.” On the other hand, in a multiple-dwelling unit (MDU) neighborhood, such as an apartment complex, if a user device 120a was moved 160 feet such a move might have exceeded the bounds of the subscriber's residence, which can be another factor indicating that the subscribe might be either sharing the device with a non-subscriber neighbor or might have given the device to a non-subscriber neighbor.

In some implementations, to consider the demographics and the timing delay of the user devices 120, a process can be performed in which timing data from all available user devices 120 on a node 205, for example, can be collected. Subscriber account data from a subscriber billing database, for example, can also be imported.

In some implementations, every user device 120 on a node can be considered for the analysis. Recorded in a database, for example, can be information regarding which node is associated with which user devices 120, or viewed another way, which user devices 120 are associated with which nodes.

In other implementations, a radius of the coaxial plant served by the node 205 (the coaxial portion of an HFC network extending from the node 205 to the subscriber homes) can be considered. To consider devices within this radius, the minimum timing offset can be subtracted from the timing offset of each user device 120. The resulting value can represent the CMTS's timing constant plus the time induced by the signal's propagation through the fiber to the node. Then, the difference in timing offset between the user devices having the minimum timing offset and maximum timing offset can represent a radius of the coaxial plant served by the node 205.

Each subscriber account can contain information regarding the subscriber's physical location, for example the residential street address, and the MAC address of one or more user devices 120 associated with the subscriber's account. Tests can be performed to verify how the accounts are distributed within the area served by the node 205 associated with the user devices 120. This data can then be used to estimate the demographics of the area. Old or outdated records can result from a network operator performing upgrades for new services or additional legs.

However, in all of these implementations, there exists shortcomings in the ability of DOCSIS to consider all of the interferences when determining the distance between a CMTS and a modem. FIG. 3 illustrates physical aspects of the network and indicates that the distance to the modem, in this example, has changed. The presence of the node highlights that there remain issues that cannot be resolved due to the node not having DOCSIS-layer information to be able to determine which leg a modem is connected.

DOCSIS protocol uses various algorithms to resolve collisions within the network by means of determining distance to a cable modem using either the ranging information that was obtained as part of the cable modem initialization process or the RF power levels at the CMTS or cable modem. However, the performance of these methods tends to deteriorate when the network load is high or there is excess noise on the network. Ranging provides a total round trip delay from the cable modem to the CMTS and back but does not account for the delay asymmetry inherent in the upstream and downstream paths. RF power levels can be affected by amplifiers in the coaxial cable plant. While DOCSIS Time Protocol is a defined protocol, the application of the protocol to accurately determine the distance from a CMTS to the cable modem is unique. DOCSIS Time Protocol (DTP) determines and accounts for delay asymmetry to allow consideration of the overall delay and as a result, distance to a particular modem to be accurately determined. This allows for much greater accuracy for troubleshooting network issues, detecting fraud, and providing additional information in cases where records are missing or outdated.

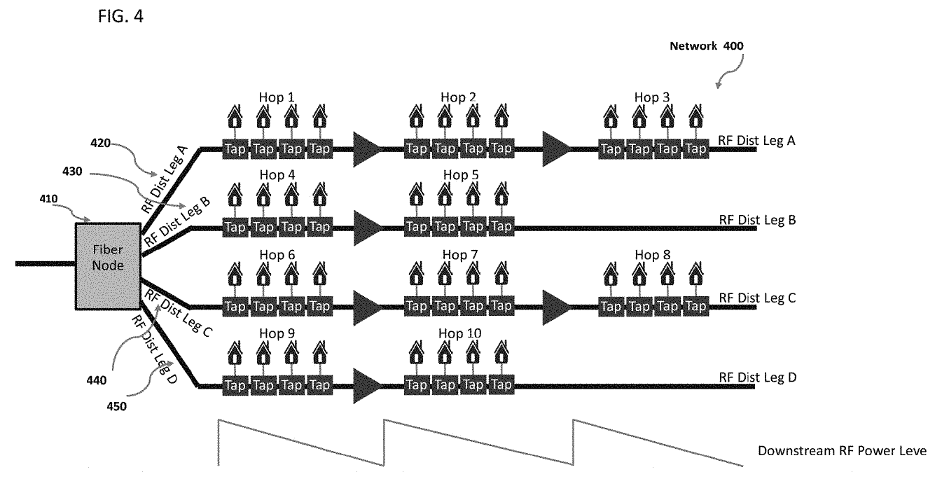

As shown in FIG. 4, amplifiers can also have an additional output that can add another distribution leg. This new leg could result from a new subdivision being constructed that is further away than the current development. In one embodiment, the manually entered record for the two legs could have been accidentally swapped and DTP can help to identify the difference in distance.

FIG. 4 shows an example network 400 diagram illustrating the problems remedied by using DOCSIS Time Protocol in order to determine the distance more accurately between a cable modem and a CMTS. FIG. 4 depicts a simplified linear representation of the example network. In the example network, the entry to the fiber node 410 is not shown in the figure. However, the CMTS, RPD, or RMD would be depicted to the left of the fiber node. The fiber node can convert the optical signal from, for example, the CMTS to an electrical signal to be distributed over the coaxial cable, to the taps, and in turn, the houses. It does not have any DOCSIS protocol awareness, so it does not know which house/cable modem is connected on which distribution leg. In this example shown in FIG. 4, there are four distribution legs.

Each distribution leg 420, 430, and 440 is shown with similar components. The test access points (TAPs) attenuate or reduce signal going through a shorter cable run and send more signal to the longer cable run to overcome cable loss. The TAP receives the signal coming from the CMTS and splits the signal into a local signal that connects to the cable modems in the houses, and another signal that is passed to the next tap in the line. In one example, a tap typically has four local outputs, allowing connection to, for example, four houses. When positioned correctly, they do not add material delay to the signal in either direction.

Also shown in FIG. 4 are the amplifiers in between each set of TAPs. The amplifier increases the signal level after the attenuation of the coaxial cable has reduced the signal. The sawtooth waveform at the bottom of the diagram illustrates an example of the downstream signal level as it progresses through a distribution leg. It can be seen that signal level cannot be used to determine distance when amplifiers are deployed. It provides amplification of signals in both directions and adds asymmetrical delay to the signal. This asymmetrical delay of an amplifier is calibrated to minimize the degradation of the distance calculation.

As shown, houses symbolize the user locations where the cable modems are deployed. It is noted that there is a length of coax cable between the tap and the house and there also is additional coaxial cable inside the house to connect to the cable modem. The term ‘hop,’ for illustrative purposes, indicates a set of taps and houses between amplifiers.

Therefore, again referring again to FIG. 4, for troubleshooting a network problem, a user may be able to localize a failed or degraded amplifier or a failed or degraded tap by determining that, for example the houses in the first hop of the first distribution leg were working well; however, half of the houses in the second hop of the first distribution leg and all of the houses in the third hop were having a problem with service or quality. By using DTP, the distance to the houses that were operating normally could be determined, and the troubleshooting can be initiated after that particular distance in the distribution let. Although pinpointing the failure to a specific amp of tap at the start may not be possible, the disclosed methods can provide information to determine a more accurate starting location for troubleshooting.

DOCSIS networks have been deployed for many years to provide wireline access to users. Using a DOCSIS infrastructure for deploying and backhauling the wireless access networks using base stations in the wireless networks, requires accurate synchronization of both time frequency and phase to a grand-master clock.

IEEE 1588 Precision Time Protocol (PTP) is a standard that establishes frequency and phase synchronization on non-deterministic Ethernet links, but it was not designed for DOCSIS networks. DOCSIS Time Protocol (DTP) solves many issues that enable DOCSIS networks to effectively deliver PTP to wireless base stations, however it is challenging to implement because the frequency and phase timing fall short of being accurate enough to meet the requirements for supporting many wireless base stations on DOCSIS networks.

When DOCSIS is lightly loaded, it has been demonstrated that it is possible to support PTP “over-the-top” of DOCSIS. But because DOCSIS was not specifically developed with highly accurate PTP in mind, a highly loaded system is not able to support PTP to the accuracy levels required by time division duplex (TDD) 5G base stations without the use of DOCSIS Time Protocol.

DOCSIS Time Protocol establishes PTP-to-DOCSIS interfaces at the CMTS and cable modem which creates a timing bridge between them. The cable modem regenerates PTP and sends it to the base station. The CMTS uses the ranging capabilities of DOCSIS and delays through the CMTS and cable modem to calculate timing offsets for an accurate PTP time stamp at the cable modem.

Time frequency and phase along with synchronization are important. A transmitter maps bits into 8-bit bytes so that multiple transmissions are multiplexed on the same channel. The transmitter uses a clock, at a predetermined time frequency to determine when to transmit the bits. The receiver samples the information at exactly the same time rate. If it does not, it may sample the same bit more than once (sampling at higher frequencies), or a bit may not be sampled at all (sampling at lower frequencies).

Phase synchronization aligns each transmission when multiple transmitters share the same channel. The transmissions are mapped into non-overlapping timeslots to avoid transmission collisions, which is called a time division multiple access (TDMA) system. For it to work, transmissions in one timeslot must not overlap transmissions in another timeslot.

With DOCSIS, there are multiple cable modems transmitting on a shared channel. The transmissions are both frequency and phase synchronized. The CMTS uses media access control (MAC) management messages so that their transmissions do not interfere with other cable modem transmissions.

Precision Time Protocol was developed to address one limitation of Ethernet, its non-deterministic nature, which makes it unable to support applications requiring accurate synchronization, for example, such as LTE and 5G. One example is time division duplex base stations must be synchronized to within a certain distance from each other, requiring each base station to be within a certain distance of a of a primary reference time clock (PRTC). PTP (IEEE 1588) was developed to address this problem, and it specifies frequency and phase synchronization across Ethernet transmission links using time stamps to address latency and jitter issues.

DOCSIS time protocol was introduced to reliably support PTP on DOCSIS networks. DOCSIS time protocol allows the timing and frequency system of the CMTS, the hybrid fiber/coax (HFC) plant and the CM to be a timing bridge that accurately takes the PTP timing source at the input of the CMTS and replicates it at the output of the cable modems with the correct timing offsets to consider all the delays through the DOCSIS system.

To do this, the CMTS receives a PTP timestamp on a PTP slave port and synchronizes its internal clock to that timestamp. The CMTS synchronizes all DOCSIS timestamps to its internal clock, which makes the DOCSIS timestamp traceable to a PTP timestamp.

DOCSIS time protocol also provides a signaling path that determines the downstream timing offset to compensate for delays through the DOCSIS system. The timing offset is used as a correction factor for the PTP timestamp at the cable modems. The DOCSIS time protocol runs between the CMTS and the cable modem. It sends the CMTS timestamp value to the cable modem, calculates the delay in the downstream path, and adds the delay to the CMTS timestamp value to generate the value for the cable modem PTP timestamp.

In DOCSIS, the MAC protocol uses a ranging procedure to determine the timing offset of each cable modem from the CMTS, so that packets sent from cable modems at different distances appear at the CMTS without overlapping timeslots.

Additional delays internal to the CMTS and the cable modem can remain unknown and may change with configuration changes. These values must also be measured so that the timing offset of the DOCSIS system can be calculated for the PTP timestamp at the output of the cable modem. Accurate time frequency and phase are required in wireless base stations, and extremely accurate timing is required in TDD wireless base stations. PTP is a protocol that supports frequency and phase requirements necessary for 5G wireless base stations and DOCSIS time protocol is the means by which DOCSIS networks are enabled to deliver PTP to them.

Knowing the position of wireless nodes is required for location-aware services and applications. The position can be calculated using the distance between wireless nodes. Furthermore, distance helps when deciding the time of handovers or finding the optimal routing path throughout an ad-hoc network. Usually, received signal strength indications are applied to identify the location of wireless nodes. In order to overcome the problem of interrupt latencies and hence inaccuracies when measuring the duration of packet transmission in the operating system, time is also measured on the hardware layer—for example, on the WLAN card. Such solutions can allow to record time stamps at a resolution of 1 μs.

Accordingly, DTP accounts for delay asymmetry and allows the overall delay to be ascertained. This leads to the distance from a CMTS to a modem to more accurately determined. Using DTP for obtaining values to compensate for delay through measurement, particularly path delay introduced by the coax cable going from the CMTS to the cable modem. This is computed based on the length of the coax cable and the speed of propagation in the coax cable. The distance can be calculated from the delay, as the propagation velocity is well-known in coax cable.

Data storage can be limited to the values that are obtained a part of the calibration process. For example, one data stored is the time adjust (t-adj) value that equalizes the delay from the network side interface of the CMTS to the Ethernet output of the cable modem. Another example is the round-trip delay (t-tro) that the cable modem measures as the total of the upstream and downstream delays.

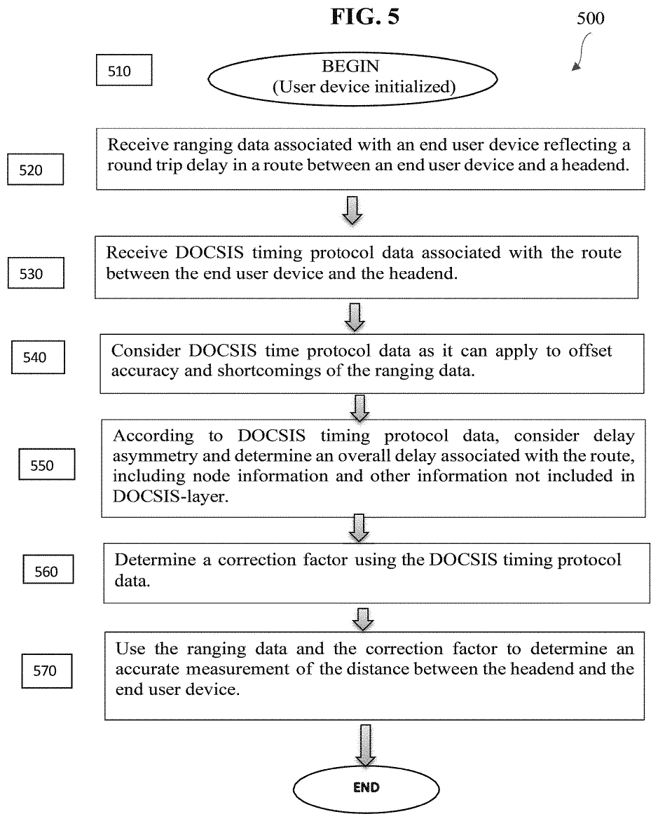

FIG. 5 is a flowchart illustrating an example process 500 for determining a geolocation of a modem and determining an accurate distance between a headend and a cable modem. Once a distance is determined, the information can be used to alert of a potential misuse, inaccurate information, or stolen cable modem perpetrated by, for example, the movement of a user device or by outdated information stored regarding the cable modem or the associated node. The example process can be performed by a software module (e.g., distance determining software 125 of FIG. 1).

The headend device, for example, the CMTS, uses the ranging capabilities of DOCSIS and delays through the CMTS and cable modem to calculate timing offsets for an accurate time stamp, for example, a PTP time stamp, at the cable modem.

The process 500 can begin at stage 510 wherein one or more user devices, which can be user devices 120 of FIG. 1, for example, have initialized and have timing offset values. As is typical in many networks, such a ranging process or the like can be performed periodically and the data regarding timing offsets of devices is not always stored for comparative purposes.

At stage 520, ranging data associated with the end user device, reflecting the route between the end user device, for example a cable modem, and the headend, such as a CTMS, is received.

At stage 530, DOCSIS time protocol data associated with the route between the end user device and the headend is obtained.

At stage 540, various data is considered to determine a correction factor to account for the shortcomings of the ranging data. The DOCSIS time protocol data provides delay symmetry data which helps determine a value for overall delay.

At stage 550, according to DOCSIS time protocol data and the delay asymmetry is considered to determine an overall delay associated with the route, including node information and other information not included in DOCSIS-layer.

At stage 560, a correction factor, using the DOCSIS time protocol data is determined.

Finally at 570, the ranging data and the correction factor are used to determine an accurate measurement of the distance between the headend and the end user device.

Any of the devices (e.g., CMTS, cable modems, EMTAs, etc.) and components thereto or software modules/programs described in this disclosure, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation to data processing apparatus. The tangible program carrier can be a propagated signal or a computer readable medium. The propagated signal is an artificially generated signal e.g., a machine generated electrical optical or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

To provide for interaction with a user, embodiments of the subject matter described in this specification can be operable to interface with a computing device having a display, e.g., a CRT (cathode ray tube), LCD (liquid crystal display), LED (light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
receiving ranging data associated with an end user device reflecting a round trip delay in a distance between the end user device and a headend; and
receiving DOCSIS time protocol data associated with the distance between the end user device and the headend,
wherein the DOCSIS time protocol data allows for a correction factor,
wherein the correction factor accounts for delay asymmetry and allows consideration of an overall delay; and
using the ranging data, and the correction factor to determine an accurate measurement of the distance between the headend and the end user device.

2. The method of claim 1, wherein the headend device is a CMTS.

3. The method of claim 1, wherein the headend device is a Remote PHY device.

4. The method of claim 1, wherein the headend device is a Remote MACPHY device.

5. The method of claim 1, wherein the end user device is a cable modem.

6. The method of claim 1, wherein the DOCSIS time protocol provides a hardware path to carry timestamps, and a signaling path to determine a downstream timing offset.

7. The method of claim 6, in which the hardware path and the signaling path provide a correction factor for which “determines the downstream timing offset, which is used in applying a correction factor.

8. The method of claim 7, wherein the correction factor can further help identify which leg a node is connected to when a node does not have DOCSIS-layer information.

9. The method of claim 1, wherein the correction factor corrects errors in the ranging data caused by amplifier traffic and delay.

10. The method of claim 1, wherein the correction factor corrects errors in the ranging data caused by deteriorated performance of a RF power level at the headend or end user device.

11. A hybrid fiber-coaxial (HFC) cable communication system, comprising:
a cable modem termination system (CMTS) receiving ranging data associated with a cable modem;
the cable modem termination system (CMTS) receiving data associated with the path between the cable modem and the CMTS;
the cable modem termination system (CMTS) receiving DOCSIS time protocol data associated with the path between the cable modem and the CMTS, wherein the DOCSIS time protocol data allows for a correction, and wherein the correction factor accounts for delay asymmetry and allows consideration of an overall delay; and
the cable modem termination system (CMTS) using the ranging data, and the correction factor to determine an accurate measurement of the distance between the cable modem and the CMTS.

12. The method of claim 11, wherein the DOCSIS time protocol provides a hardware path to carry timestamps, and a signaling path to determine a downstream timing offset.

13. The method of claim 12, in which the hardware path and the signaling path provide a correction factor for which determines the downstream timing offset, which is used in applying a correction factor.

14. The method of claim 13, wherein the correction factor can further help identify which leg a node is connected to when a node does not have DOCSIS-layer information.

15. The method of claim 11, wherein the correction factor corrects errors in the ranging data caused by amplifier traffic and delay.

16. The method of claim 11, wherein the correction factor addresses errors in the ranging data caused by deteriorated performance of an RF power level at the cable modem or CMTS.
